(19) United States
(12) Patent Application Publication
(10) Pub. No.: US 2016/0013891 A1
(43) Pub. Date: Jan. 14, 2016

(54) FEEDBACK INFORMATION TRANSMISSION METHOD, USER EQUIPMENT, AND BASE STATION

(71) Applicant: HUAWEI TECHNOLOGIES CO., LTD., Shenzhen (CN)

(72) Inventors: Tong JI, Beijing (CN); Yongxia LYU, Beijing (CN)

(73) Assignee: HUAWEI TECHNOLOGIES CO., LTD., Shenzhen (CN)

(21) Appl. No.: 14/859,814

(22) Filed: Sep. 21, 2015

Related U.S. Application Data
(63) Continuation of application No. PCT/CN2013/073427, filed on Mar. 29, 2013.

(51) Int. Cl. H04L 1/16; H04W 48/16; H04W 24/02

(52) U.S. Cl. CPC H04L 1/16; H04W 24/02; H04W 48/16

(57) ABSTRACT

The present invention provides a feedback information transmission method, user equipment, and a base station. The method includes: sending, by user equipment UE, uplink data and identity information that is corresponding to the UE to a base station eNB; and receiving, by the UE, downlink feedback information of the UE that is sent by the eNB according to the identity information. By using a feedback information transmission method, user equipment, and a base station that are provided by the present invention, reliability of a communications system that uses a connectionless data transmission manner is improved.

### CROSS-REFERENCE TO RELATED APPLICATIONS

This application is a continuation of International Application No. PCT/CN 2013/073427, filed on Mar. 29, 2013, which is hereby incorporated by reference in its entirety.

### TECHNICAL FIELD

Embodiments of the present invention relate to mobile communications technologies, and in particular, to a feedback information transmission method, user equipment (UE), and a base station (Evolved NodeB, eNB for short).

### BACKGROUND

In a Long Term Evolution (LTE) communications system, data is sent in a manner of establishing a connection, and UE first establishes a connection to an eNB after achieving synchronization by means of random access and then sends data.

The foregoing manner of sending data by establishing a connection is not applicable to an application scenario, such as an Machine to Machine (M2M) network system, in which a large quantity of small data packets exist. In comparison, a connectionless data transmission manner is more suitable for transmission of a small data packet. The connectionless data transmission manner refers to a data transmission manner defined in non-LTE release 8 to release 11, and is a manner in which data can be transmitted without performing at least one of the following operations: achieving uplink synchronization by means of random access, establishing a Radio Resource Control (RRC) Protocol connection, and establishing a radio bearer.

In the connectionless data transmission manner, there is a case in which multiple UEs send uplink data to an eNB in a same time-frequency resource, which causes that the eNB cannot successfully receive the uplink data of all the UEs. Because there is no method for transmitting feedback information by an eNB to UE in the prior art, when the eNB does not successfully receive uplink data of UE, that the eNB does not successfully receive the uplink data of the UE cannot be learned by the UE; as a result, the UE does not resend the uplink data to the eNB, causing that reliability of a communications system that uses the connectionless data transmission manner is low.

### SUMMARY

A first aspect of the present invention provides a feedback information transmission method, so as to overcome a defect in the prior art, and improve reliability of a communications system that uses a connectionless data transmission manner.

Another aspect of the present invention provides UE and an eNB, so as to overcome a defect in the prior art, and improve reliability of a communications system that uses a connectionless data transmission manner.

A first aspect of the present invention provides a feedback information transmission method, including:

sending, by user equipment UE, uplink data and identity information that is corresponding to the UE to a base station eNB; and

receiving, by the UE, downlink feedback information of the UE that is sent by the eNB according to the identity information.

With reference to the aspect and any possible implementation manner that are described above, an implementation manner is further provided, where

the identity information includes at least one of a random code, a preamble sequence, and interleaver information.

With reference to the aspect and any possible implementation manner that are described above, an implementation manner is further provided, where the receiving, by the UE, downlink feedback information of the UE that is sent by the eNB according to the identity information includes:

receiving, by the UE in a determined downlink time-frequency resource that is corresponding to the UE, the downlink feedback information sent by the eNB, where the downlink feedback information includes success indication information or failure indication information.

With reference to the aspect and any possible implementation manner that are described above, an implementation manner is further provided, where before the receiving, by the UE in a determined downlink time-frequency resource that is corresponding to the UE, the downlink feedback information sent by the eNB, the method further includes:

determining, by the UE according to a preset resource mapping policy, the downlink time-frequency resource that is corresponding to the UE.

With reference to the aspect and any possible implementation manner that are described above, an implementation manner is further provided, where the resource mapping policy includes:

determining, according to an uplink time-frequency resource of the uplink data sent by the UE and the identity information that is corresponding to the UE, the downlink time-frequency resource that is corresponding to the UE; or

determining, according to the identity information that is corresponding to the UE, the downlink time-frequency resource that is corresponding to the UE.

With reference to the aspect and any possible implementation manner that are described above, an implementation manner is further provided, where

the determining, according to an uplink time-frequency resource of the uplink data sent by the UE and the identity information that is corresponding to the UE, the downlink time-frequency resource that is corresponding to the UE includes: calculating, according to q=(p×m+i)mod(rmax), the downlink time-frequency resource that is corresponding to the UE, where q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources; and

the determining, according to the identity information that is corresponding to the UE, the downlink time-frequency resource that is corresponding to the UE includes: calculating, according to q=imod(rmax), the downlink time-frequency resource that is corresponding to the UE, where q indicates an identifier of the downlink time-frequency resource that is corresponding to the UE, i indicates a sequence number of the identity information that is corresponding to the UE, and rmax indicates a maximum available quantity of downlink time-frequency resources.

With reference to the aspect and any possible implementation manner that are described above, an implementation manner is further provided, where

the identity information includes at least one of a Media Access Control MAC address, a UE identifier, an Internet Protocol IP address, and partial information of the uplink data.

With reference to the aspect and any possible implementation manner that are described above, an implementation manner is further provided, where the receiving, by the UE, downlink feedback information of the UE that is sent by the eNB according to the identity information includes:

receiving, by the UE in a downlink time-frequency resource of the downlink feedback information to be received, the downlink feedback information sent by the eNB, where the downlink feedback information includes the identity information of the UE that is successfully received by the eNB.

With reference to the aspect and any possible implementation manner that are described above, an implementation manner is further provided, where before the receiving, by the UE in a downlink time-frequency resource of the downlink feedback information to be received, the downlink feedback information sent by the eNB, the method further includes:

receiving, by the UE, indication information of the downlink feedback information according to a determined temporary identifier, where the indication information of the downlink feedback information includes the downlink time-frequency resource and a feedback packet size of the downlink feedback information.

With reference to the aspect and any possible implementation manner that are described above, an implementation manner is further provided, where before the receiving, by the UE, indication information of the downlink feedback information according to a determined temporary identifier, the method further includes:

determining, by the UE, the temporary identifier according to a time-frequency resource of the uplink data sent by the UE.

Another aspect of the present invention provides a feedback information transmission method, including:

receiving, by a base station eNB, uplink data and identity information corresponding to user equipment UE that are from the UE; and

sending, by the eNB, downlink feedback information of the UE to the UE according to the identity information.

With reference to the aspect and any possible implementation manner that are described above, an implementation manner is further provided, where

the identity information includes at least one of a random code, a preamble sequence, and interleaver information.

With reference to the aspect and any possible implementation manner that are described above, an implementation manner is further provided, where the sending, by the eNB, downlink feedback information of the UE to the UE according to the identity information includes: sending, by the eNB, the downlink feedback information of the UE in a determined downlink time-frequency resource that is corresponding to the UE, where the downlink feedback information includes success indication information or failure indication information.

With reference to the aspect and any possible implementation manner that are described above, an implementation manner is further provided, where before the sending, by the eNB, the downlink feedback information of the UE in a determined downlink time-frequency resource that is corresponding to the UE, the method further includes:

determining, by the eNB according to a preset resource mapping policy, the downlink time-frequency resource that is corresponding to the UE.

With reference to the aspect and any possible implementation manner that are described above, an implementation manner is further provided, where the resource mapping policy includes:

determining, according to an uplink time-frequency resource of the uplink data sent by the UE and the identity information that is corresponding to the UE, the downlink time-frequency resource that is corresponding to the UE; or

determining, according to the identity information that is corresponding to the UE, the downlink time-frequency resource that is corresponding to the UE.

With reference to the aspect and any possible implementation manner that are described above, an implementation manner is further provided, where

the determining, according to an uplink time-frequency resource of the uplink data sent by the UE and the identity information that is corresponding to the UE, the downlink time-frequency resource that is corresponding to the UE includes: calculating, according to q=(p×m+i)mod(rmax), the downlink time-frequency resource that is corresponding to the UE, where q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources; and

the determining, according to the identity information that is corresponding to the UE, the downlink time-frequency resource that is corresponding to the UE includes: calculating, according to q=imod(rmax), the downlink time-frequency resource that is corresponding to the UE, where q indicates an identifier of the downlink time-frequency resource that is corresponding to the UE, i indicates a sequence number of the identity information that is corresponding to the UE, and rmax indicates a maximum available quantity of downlink time-frequency resources.

With reference to the aspect and any possible implementation manner that are described above, an implementation manner is further provided, where

the identity information includes at least one of a Media Access Control MAC address, a UE identifier, an Internet Protocol IP address, and partial information of the uplink data.

With reference to the aspect and any possible implementation manner that are described above, an implementation manner is further provided, where the sending, by the eNB, downlink feedback information of the UE to the UE according to the identity information includes:

sending, by the eNB, the downlink feedback information in a downlink time-frequency resource of the downlink feedback information, where the downlink feedback information includes the identity information of the UE that is successfully received by the eNB.

With reference to the aspect and any possible implementation manner that are described above, an implementation manner is further provided, where before the sending, by the eNB, the downlink feedback information in a downlink time-frequency resource of the downlink feedback information, the method further includes:

sending, by the eNB, indication information, which is processed by using a determined temporary identifier, of the downlink feedback information, where the indication information of the downlink feedback information includes the downlink time-frequency resource and a feedback packet size of the downlink feedback information.

With reference to the aspect and any possible implementation manner that are described above, an implementation manner is further provided, where before the sending, by the eNB, indication information, which is processed by using a determined temporary identifier, of the downlink feedback information, the method further includes:

determining, by the eNB, the temporary identifier according to a time-frequency resource of the uplink data sent by the UE.

Another aspect of the present invention provides user equipment UE, including:

a sending unit, configured to send uplink data and identity information that is corresponding to the UE to a base station eNB; and

a receiving unit, configured to receive downlink feedback information of the UE that is sent by the eNB according to the identity information.

With reference to the aspect and any possible implementation manner that are described above, an implementation manner is further provided, where

the identity information includes at least one of a random code, a preamble sequence, and interleaver information.

With reference to the aspect and any possible implementation manner that are described above, an implementation manner is further provided, where

the receiving unit is specifically configured to receive, in a determined downlink time-frequency resource that is corresponding to the UE, the downlink feedback information sent by the eNB, where the downlink feedback information includes success indication information or failure indication information.

With reference to the aspect and any possible implementation manner that are described above, an implementation manner is further provided, where

the receiving unit is further specifically configured to determine, according to a preset resource mapping policy, the downlink time-frequency resource that is corresponding to the UE.

With reference to the aspect and any possible implementation manner that are described above, an implementation manner is further provided, where the resource mapping policy includes:

determining, according to an uplink time-frequency resource of the uplink data sent by the UE and the identity information that is corresponding to the UE, the downlink time-frequency resource that is corresponding to the UE; or

determining, according to the identity information that is corresponding to the UE, the downlink time-frequency resource that is corresponding to the UE.

With reference to the aspect and any possible implementation manner that are described above, an implementation manner is further provided, where

the determining, according to an uplink time-frequency resource of the uplink data sent by the UE and the identity information that is corresponding to the UE, the downlink time-frequency resource that is corresponding to the UE includes: calculating, according to q=(p×m+i)mod(rmax), the downlink time-frequency resource that is corresponding to the UE, where q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources; and

the determining, according to the identity information that is corresponding to the UE, the downlink time-frequency resource that is corresponding to the UE includes: calculating, according to q=imod(rmax), the downlink time-frequency resource that is corresponding to the UE, where q indicates an identifier of the downlink time-frequency resource that is corresponding to the UE, i indicates a sequence number of the identity information that is corresponding to the UE, and rmax indicates a maximum available quantity of downlink time-frequency resources.

With reference to the aspect and any possible implementation manner that are described above, an implementation manner is further provided, where

the identity information includes a Media Access Control MAC address, a UE identifier, an Internet Protocol IP address, or partial information of the uplink data.

With reference to the aspect and any possible implementation manner that are described above, an implementation manner is further provided, where

the receiving unit is specifically configured to receive, in a downlink time-frequency resource of the downlink feedback information to be received, the downlink feedback information sent by the eNB, where the downlink feedback information includes the identity information of the UE that is successfully received by the eNB.

With reference to the aspect and any possible implementation manner that are described above, an implementation manner is further provided, where

the receiving unit is further specifically configured to receive indication information of the downlink feedback information according to a determined temporary identifier, where the indication information of the downlink feedback information includes the downlink time-frequency resource and a feedback packet size of the downlink feedback information.

With reference to the aspect and any possible implementation manner that are described above, an implementation manner is further provided, where

the receiving unit is further specifically configured to determine the temporary identifier according to a time-frequency resource of the uplink data sent by the UE.

Another aspect of the present invention provides a base station eNB, including:

a receiving unit, configured to receive uplink data and identity information corresponding to user equipment UE that are from the UE; and

a sending unit, configured to send downlink feedback information of the UE to the UE according to the identity information.

With reference to the aspect and any possible implementation manner that are described above, an implementation manner is further provided, where

the identity information includes at least one of a random code, a preamble sequence, and interleaver information.

With reference to the aspect and any possible implementation manner that are described above, an implementation manner is further provided, where

the sending unit is specifically configured to send the downlink feedback information of the UE in a determined downlink time-frequency resource that is corresponding to the UE, where the downlink feedback information includes success indication information or failure indication information.

With reference to the aspect and any possible implementation manner that are described above, an implementation manner is further provided, where

the sending unit is further specifically configured to determine, according to a preset resource mapping policy, the downlink time-frequency resource that is corresponding to the UE.

With reference to the aspect and any possible implementation manner that are described above, an implementation manner is further provided, where the resource mapping policy includes:

determining, according to an uplink time-frequency resource of the uplink data sent by the UE and the identity information that is corresponding to the UE, the downlink time-frequency resource that is corresponding to the UE; or

determining, according to the identity information that is corresponding to the UE, the downlink time-frequency resource that is corresponding to the UE.

With reference to the aspect and any possible implementation manner that are described above, an implementation manner is further provided, where

the determining, according to an uplink time-frequency resource of the uplink data sent by the UE and the identity information that is corresponding to the UE, the downlink time-frequency resource that is corresponding to the UE includes: calculating, according to q=(p×m+i)mod(rmax), the downlink time-frequency resource that is corresponding to the UE, where q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources; and

the determining, according to the identity information that is corresponding to the UE, the downlink time-frequency resource that is corresponding to the UE includes: calculating, according to q=imod(rmax), the downlink time-frequency resource that is corresponding to the UE, where q indicates an identifier of the downlink time-frequency resource that is corresponding to the UE, i indicates a sequence number of the identity information that is corresponding to the UE, and rmax indicates a maximum available quantity of downlink time-frequency resources.

With reference to the aspect and any possible implementation manner that are described above, an implementation manner is further provided, where

the identity information includes at least one of a Media Access Control MAC address, a UE identifier, an Internet Protocol IP address, and partial information of the uplink data.

With reference to the aspect and any possible implementation manner that are described above, an implementation manner is further provided, where

the sending unit is specifically configured to send the downlink feedback information in a downlink time-frequency resource of the downlink feedback information, where the downlink feedback information includes the identity information of the UE that is successfully received by the eNB.

With reference to the aspect and any possible implementation manner that are described above, an implementation manner is further provided, where

the sending unit is further specifically configured to send indication information, which is processed by using a determined temporary identifier, of the downlink feedback information, where the indication information of the downlink feedback information includes the downlink time-frequency resource and a feedback packet size of the downlink feedback information.

With reference to the aspect and any possible implementation manner that are described above, an implementation manner is further provided, where

the sending unit is further specifically configured to determine the temporary identifier according to a time-frequency resource of the uplink data sent by the UE.

Another aspect of the present invention provides user equipment UE, including:

a transmitter, configured to send uplink data and identity information that is corresponding to the UE to a base station eNB;

a receiver, configured to receive downlink feedback information of the UE that is sent by the eNB according to the identity information;

a memory, configured to store the identity information that is corresponding to the UE; and

a bus, configured to connect the transmitter, the receiver, and the memory, where the transmitter, the receiver, and the memory communicate with one another by using the bus.

With reference to the aspect and any possible implementation manner that are described above, an implementation manner is further provided, where

the identity information includes at least one of a random code, a preamble sequence, and interleaver information.

With reference to the aspect and any possible implementation manner that are described above, an implementation manner is further provided, where

the receiver is specifically configured to receive, in a determined downlink time-frequency resource that is corresponding to the UE, the downlink feedback information sent by the eNB, where the downlink feedback information includes success indication information or failure indication information.

With reference to the aspect and any possible implementation manner that are described above, an implementation manner is further provided, where

the receiver is further specifically configured to determine, according to a preset resource mapping policy, the downlink time-frequency resource that is corresponding to the UE.

With reference to the aspect and any possible implementation manner that are described above, an implementation manner is further provided, where the resource mapping policy includes:

determining, according to an uplink time-frequency resource of the uplink data sent by the UE and the identity information that is corresponding to the UE, the downlink time-frequency resource that is corresponding to the UE; or

determining, according to the identity information that is corresponding to the UE, the downlink time-frequency resource that is corresponding to the UE.

With reference to the aspect and any possible implementation manner that are described above, an implementation manner is further provided, where

the determining, according to an uplink time-frequency resource of the uplink data sent by the UE and the identity information that is corresponding to the UE, the downlink time-frequency resource that is corresponding to the UE includes: calculating, according to q=(p×m+i)mod(rmax), the downlink time-frequency resource that is corresponding to the UE, where q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources; and

the determining, according to the identity information that is corresponding to the UE, the downlink time-frequency resource that is corresponding to the UE includes: calculating, according to q=imod(rmax), the downlink time-frequency resource that is corresponding to the UE, where q indicates an identifier of the downlink time-frequency resource that is corresponding to the UE, i indicates a sequence number of the identity information that is corresponding to the UE, and rmax indicates a maximum available quantity of downlink time-frequency resources.

With reference to the aspect and any possible implementation manner that are described above, an implementation manner is further provided, where

the identity information includes at least one of a Media Access Control MAC address, a UE identifier, an Internet Protocol IP address, and partial information of the uplink data.

With reference to the aspect and any possible implementation manner that are described above, an implementation manner is further provided, where

the receiver is specifically configured to receive, in a downlink time-frequency resource of the downlink feedback information to be received, the downlink feedback information sent by the eNB, where the downlink feedback information includes the identity information of the UE that is successfully received by the eNB.

With reference to the aspect and any possible implementation manner that are described above, an implementation manner is further provided, where

the receiver is further specifically configured to receive indication information of the downlink feedback information according to a determined temporary identifier, where the indication information of the downlink feedback information includes the downlink time-frequency resource and a feedback packet size of the downlink feedback information.

With reference to the aspect and any possible implementation manner that are described above, an implementation manner is further provided, where

the receiver is further specifically configured to determine the temporary identifier according to a time-frequency resource of the uplink data sent by the UE.

Another aspect of the present invention provides a base station eNB, including:

a receiver, configured to receive uplink data and identity information corresponding to user equipment UE that are from the UE;

a transmitter, configured to send downlink feedback information of the UE to the UE according to the identity information;

a memory, configured to store the identity information that is corresponding to the UE; and

a bus, configured to connect the transmitter, the receiver, and the memory, where the transmitter, the receiver, and the memory communicate with one another by using the bus.

With reference to the aspect and any possible implementation manner that are described above, an implementation manner is further provided, where

the identity information includes at least one of a random code, a preamble sequence, and interleaver information.

With reference to the aspect and any possible implementation manner that are described above, an implementation manner is further provided, where

the transmitter is specifically configured to send the downlink feedback information of the UE in a determined downlink time-frequency resource that is corresponding to the UE, where the downlink feedback information includes success indication information or failure indication information.

With reference to the aspect and any possible implementation manner that are described above, an implementation manner is further provided, where

the transmitter is further specifically configured to determine, according to a preset resource mapping policy, the downlink time-frequency resource that is corresponding to the UE.

With reference to the aspect and any possible implementation manner that are described above, an implementation manner is further provided, where the resource mapping policy includes:

determining, according to an uplink time-frequency resource of the uplink data sent by the UE and the identity information that is corresponding to the UE, the downlink time-frequency resource that is corresponding to the UE; or

determining, according to the identity information that is corresponding to the UE, the downlink time-frequency resource that is corresponding to the UE.

With reference to the aspect and any possible implementation manner that are described above, an implementation manner is further provided, where

the determining, according to an uplink time-frequency resource of the uplink data sent by the UE and the identity information that is corresponding to the UE, the downlink time-frequency resource that is corresponding to the UE includes: calculating, according to q=(p×m+i)mod(rmax), the downlink time-frequency resource that is corresponding to the UE, where q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources; and

the determining, according to the identity information that is corresponding to the UE, the downlink time-frequency resource that is corresponding to the UE includes: calculating, according to q=imod(rmax), the downlink time-frequency resource that is corresponding to the UE, where q indicates an identifier of the downlink time-frequency resource that is corresponding to the UE, i indicates a sequence number of the identity information that is corresponding to the UE, and rmax indicates a maximum available quantity of downlink time-frequency resources.

With reference to the aspect and any possible implementation manner that are described above, an implementation manner is further provided, where

the identity information includes at least one of a Media Access Control MAC address, a UE identifier, an Internet Protocol IP address, and partial information of the uplink data.

With reference to the aspect and any possible implementation manner that are described above, an implementation manner is further provided, where

the transmitter is specifically configured to send the downlink feedback information in a downlink time-frequency resource of the downlink feedback information, where the downlink feedback information includes the identity information of the UE that is successfully received by the eNB.

With reference to the aspect and any possible implementation manner that are described above, an implementation manner is further provided, where

the transmitter is further specifically configured to send indication information, which is processed by using a determined temporary identifier, of the downlink feedback information, where the indication information of the downlink feedback information includes the downlink time-frequency resource and a feedback packet size of the downlink feedback information.

With reference to the aspect and any possible implementation manner that are described above, an implementation manner is further provided, where

the transmitter is further specifically configured to determine the temporary identifier according to a time-frequency resource of the uplink data sent by the UE.

It can be seen from the foregoing summary that UE adds identity information that is corresponding to the UE while sending uplink data, and an eNB returns downlink feedback information to the UE according to the identity information, so that when the eNB does not successfully receive uplink data of all UEs, UE can learn, by using feedback information from the eNB, whether uplink data sent by the UE is successfully received by the eNB; therefore, in a case in which the eNB does not successfully receives the uplink data, the UE may resend the uplink data to the eNB, until the eNB successfully receives the uplink data, thereby ensuring that the eNB can successfully receive the uplink data sent by the UE, and improving reliability of a communications system that uses a connectionless data transmission manner.

### BRIEF DESCRIPTION OF DRAWINGS

To describe the technical solutions in the embodiments of the present invention or in the prior art more clearly, the following briefly introduces the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 is a flowchart of a feedback information transmission method according to Embodiment 1 of the present invention;

FIG. 2 is a flowchart of a feedback information transmission method according to Embodiment 2 of the present invention;

FIG. 3 is a flowchart of a feedback information transmission method according to Embodiment 3 of the present invention;

FIG. 4 is a flowchart of a feedback information transmission method according to Embodiment 4 of the present invention;

FIG. 5 is a schematic structural diagram of UE according to Embodiment 5 of the present invention;

FIG. 6 is a schematic structural diagram of an eNB according to Embodiment 6 of the present invention;

FIG. 7 is a schematic structural diagram of UE according to Embodiment 7 of the present invention; and

FIG. 8 is a schematic structural diagram of an eNB according to Embodiment 8 of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some rather than all of the embodiments of the present invention. All other embodiments obtained by persons of ordinary skill in the art based on the embodiments of the present invention without creative efforts shall fall within the protection scope of the present invention.

In the embodiments of the present invention, UE sends uplink data to an eNB in a connectionless data transmission manner; the eNB receives the uplink data from the UE in the connectionless data transmission manner, and returns downlink feedback information to the UE by using methods provided in the embodiments of the present invention; and the UE learns, by using the downlink feedback information, whether the uplink data is successfully or unsuccessfully received, and resends the uplink data to the eNB when the uplink data is unsuccessfully received.

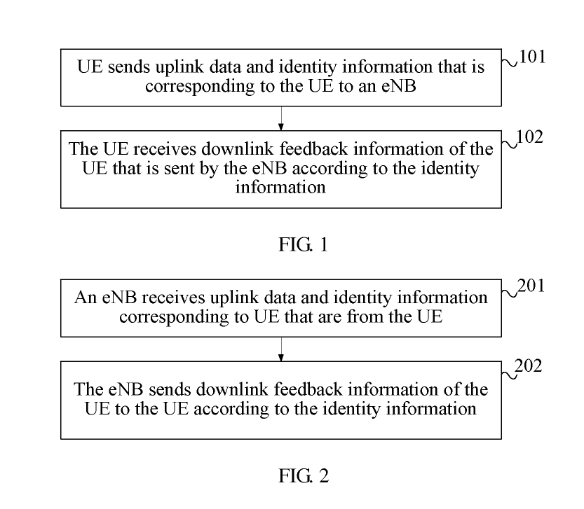

FIG. 1 is a flowchart of a feedback information transmission method according to Embodiment 1 of the present invention. As shown in FIG. 1, the method includes the following process.

Step 101: UE sends uplink data and identity information that is corresponding to the UE to an eNB.

In this step, the UE uses a connectionless data transmission manner, that is, when the UE needs to send uplink data, the UE does not perform a connection operation, but directly sends the uplink data to the eNB. In the embodiments of the present invention, the UE sends the identity information that is corresponding to the UE while sending the uplink data. Identity information of each UE is used to distinguish the UE from other UEs.

Step 102: The UE receives downlink feedback information of the UE that is sent by the eNB according to the identity information.

In this step, the UE receives the downlink feedback information, learns, according to the downlink feedback information, whether the uplink data is successfully or unsuccessfully received, and resends the uplink data to the eNB when the uplink data is unsuccessfully received.

In Embodiment 1 of the present invention, UE adds identity information that is corresponding to the UE while sending uplink data, and after sending the uplink data, the UE receives downlink feedback information that is sent by an eNB according to the identity information, so that when the eNB does not successfully receive uplink data of all UEs, UE can learn, by using feedback information from the eNB, whether uplink data sent by the UE is successfully received by the eNB; therefore, in a case in which the eNB does not successfully receive the uplink data, the UE may resend the uplink data to the eNB, until the eNB successfully receives the uplink data, thereby ensuring that the eNB can successfully receive the uplink data sent by the UE, and improving reliability of a communications system that uses a connectionless data transmission manner.

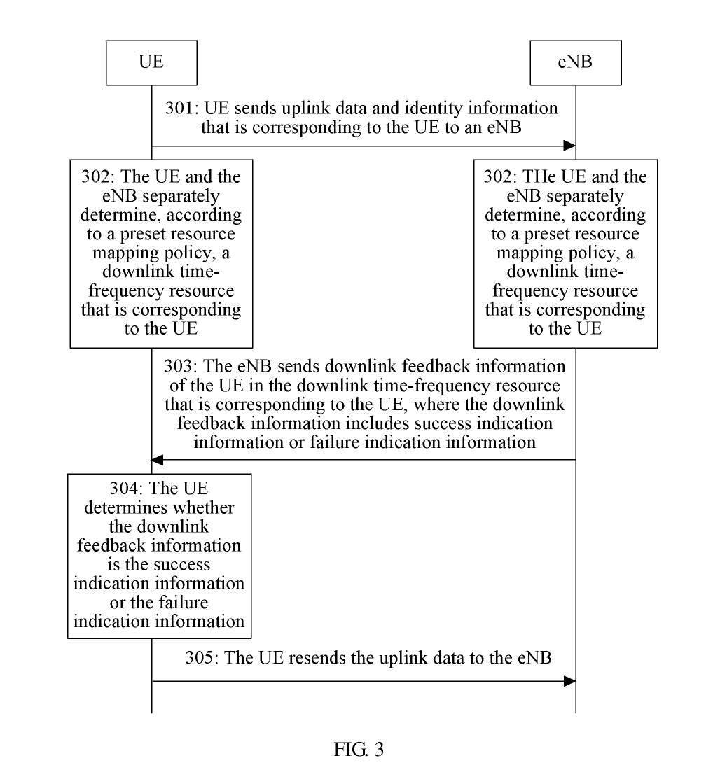

FIG. 2 is a flowchart of a feedback information transmission method according to Embodiment 2 of the present invention. As shown in FIG. 2, the method includes the following process.

Step 201: An eNB receives uplink data and identity information corresponding to UE that are from the UE.

In this step, when the UE needs to send uplink data, a connectionless data transmission manner is used, that is, the UE does not perform a connection operation, and directly sends the uplink data to the eNB. The UE also sends the identity information that is corresponding to the UE while sending the uplink data. Correspondingly, the eNB receives, in the connectionless data transmission manner, the uplink data and the identity information corresponding to the UE that are from the UE. Identity information of each UE is used to distinguish the UE from other UEs.

Step 202: The eNB sends downlink feedback information of the UE to the UE according to the identity information.

In this step, the eNB sends the downlink feedback information to the UE, so that the UE learns, according to the downlink feedback information, whether the uplink data is successfully or unsuccessfully received, and resends the uplink data to the eNB when the uplink data is unsuccessfully received.

In Embodiment 2 of the present invention, an eNB receives uplink data that is sent by UE and that carries identity information that is corresponding to the UE, and the eNB sends, according to the identity information, downlink feedback information that is corresponding to the UE, so that when the eNB does not successfully receive uplink data of all UEs, the eNB can notify each UE whether uplink data sent by the UE is successfully received by the eNB; therefore, in a case in which the eNB does not successfully receive the uplink data, the UE may resend the uplink data to the eNB, until the eNB successfully receives the uplink data, thereby ensuring that the eNB can successfully receive the uplink data sent by the UE, and improving reliability of a communications system that uses a connectionless data transmission manner.

In the foregoing Embodiment 1 of the present invention and Embodiment 2 of the present invention, the identity information of the UE may use two manners, and correspondingly, the eNB may also send the downlink feedback information to the UE in two manners. The two manners are introduced below by using Embodiment 3 of the present invention and Embodiment 4 of the present invention.

FIG. 3 is a flowchart of a feedback information transmission method according to Embodiment 3 of the present invention. As shown in FIG. 3, the method includes the following process.

Step 301: UE sends uplink data and identity information that is corresponding to the UE to an eNB.

In this step, the UE sends the uplink data to the eNB in a connectionless data transmission manner, and adds the identity information that is corresponding to the UE while sending the uplink data.

In Embodiment 3 of the present invention, the identity information may use at least one piece of the following information: a random code, a preamble sequence, and interleaver information. Specifically, the identity information may be a fixed value set by a communications system, and a length of the identity information may be 4 bits to 16 bits. In such an implementation manner, a case in which multiple UEs are corresponding to same identity information may occur. In an actual application, a probability that identity information of UEs is duplicate may be reduced by adjusting a length of the identity information according to an actual situation of the communications system. For example, if the length of the identity information is 4 bits, the probability that the identity information of the UEs is duplicate is 1/16; and if the length of the identity information is 6 bits, the probability that the identity information of the UEs is duplicate is 1/64. As can be seen from this, the probability that the identity information of the UEs is duplicate may be reduced by increasing the length of the identity information.

Step 302: The UE and the eNB separately determine, according to a preset resource mapping policy, a downlink time-frequency resource that is corresponding to the UE.

In this step, downlink feedback information of different UEs is distinguished according to an uplink time-frequency resource of uplink data sent by each UE and identity information that is corresponding to each UE, or according to only identity information that is corresponding to each UE. A manner used in Embodiment 3 of the present invention is that: downlink feedback information sent to different UEs is distinguished based on transmission channels on which the downlink feedback information is sent, that is, a downlink time-frequency resource in which the downlink feedback information is sent is divided into several channels according to resource start identifiers of the uplink data and the identity information, or according to only the identity information, where each channel is corresponding to a different UE, and each channel is used to send downlink feedback information to a different UE. A downlink time-frequency resource that is corresponding to each UE is determined, so that the downlink feedback information sent to the different UEs is distinguished by distinguishing downlink time-frequency resources that are corresponding to different UEs.

Specifically, the eNB and the UE determine, according to the preset resource mapping policy, the downlink time-frequency resource that is corresponding to the UE. The resource mapping policy may be either of the following two manners, provided that the eNB and the UE use a same resource mapping policy. Manner 1: Determining, according to an uplink time-frequency resource of the uplink data sent by the UE and the identity information that is corresponding to the UE, the downlink time-frequency resource that is corresponding to the UE. Manner 2: Determining, according to the identity information that is corresponding to the UE, the downlink time-frequency resource that is corresponding to the UE.

Manner 1:

A specific method for determining, by the eNB, the downlink time-frequency resource that is corresponding to the UE is: calculating, by the eNB according to the following formula, the downlink time-frequency resource that is corresponding to the UE:

q=(p×m+i)mod(rmax), where

q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources.

For example, there are totally 16 uplink time-frequency resources, whose sequence numbers are 0 to 15, and the sequence number of each uplink time-frequency resource is used as an identifier of the uplink time-frequency resource. The length of the identity information is, for example, 4 bits, and then there are totally 16 types of identity information, that is, m=16. Sequence numbers of the identity information are 0 to 15, and the sequence numbers of the identity information may be sorted in ascending order according to actual binary values. A maximum available quantity of downlink time-frequency resources is, for example, 200, that is, rmax=200, and the downlink time-frequency resources include 200 channels, whose numbers are 0 to 199. If the identifier of the uplink time-frequency resource of the uplink data sent by the UE is 14, and a binary value of the identity information carried by the uplink data is 1111, that is, a sequence number of the identity information is 15, an identifier of the downlink time-frequency resource that is corresponding to the UE is: q=(p×m+i)mod(rmax)=(14×16+15)mod(200)=24, that is, the downlink time-frequency resource that is corresponding to the UE is a downlink feedback channel whose number is 24.

Correspondingly, after sending the uplink data and the identity information that is corresponding to the UE, the UE also determines, according to the uplink time-frequency resource of the sent uplink data and the corresponding identity information, the downlink time-frequency resource that is corresponding to the UE. Specifically, a specific method for determining, by the UE, the downlink time-frequency resource that is corresponding to the UE is: calculating, by the UE according to the following formula, the downlink time-frequency resource that is corresponding to the UE:

q=(p×m+i)mod(rmax), where

q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources.

Manner 2:

A specific method for determining, by the eNB, the downlink time-frequency resource that is corresponding to the UE is: calculating, by the eNB according to the following formula, the downlink time-frequency resource that is corresponding to the UE:

q=imod(rmax), where

q indicates an identifier of the downlink time-frequency resource that is corresponding to the UE, i indicates a sequence number of the identity information that is corresponding to the UE, and rmax indicates a maximum available quantity of downlink time-frequency resources.

Correspondingly, after sending the uplink data and the identity information that is corresponding to the UE, the UE also determines, according to the identity information, the downlink time-frequency resource that is corresponding to the UE. Specifically, a specific method for determining, by the UE, the downlink time-frequency resource that is corresponding to the UE is: calculating, by the UE according to the following formula, the downlink time-frequency resource that is corresponding to the UE:

q=imod(rmax), where

q indicates an identifier of the downlink time-frequency resource that is corresponding to the UE, i indicates a sequence number of the identity information that is corresponding to the UE, and rmax indicates a maximum available quantity of downlink time-frequency resources.

Step 303: The eNB sends downlink feedback information of the UE in the downlink time-frequency resource that is corresponding to the UE, where the downlink feedback information includes success indication information or failure indication information.

In this step, the eNB sends, in a downlink time-frequency resource that is corresponding to UE and that is obtained through calculation in step 302, downlink feedback information that is corresponding to the UE. Correspondingly, the UE receives, in the downlink time-frequency resource that is corresponding to the UE, the downlink feedback information sent by the eNB. The downlink feedback information includes success indication information or failure indication information. Specifically, in an implementation manner, the success indication information or failure indication information may be an energy symbol on the channel. If the energy symbol is present, the success indication information is indicated; otherwise, if the energy symbol is not present, the failure indication information is indicated. Alternatively, in another implementation manner, the success indication information or failure indication information may be information being one bit; if a value of the bit is 1, the success indication information is indicated; or if a value of the bit is 0, the failure indication information is indicated.

Step 304: The UE determines whether the downlink feedback information is the success indication information or the failure indication information.

In this step, the UE receives, in the downlink time-frequency resource that is corresponding to the UE, the downlink feedback information sent by the eNB, where the downlink feedback information includes the success indication information or the failure indication information, and the UE determines whether the downlink feedback information is the success indication information or the failure indication information. If the downlink feedback information is the success indication information, the process is ended; and if the downlink feedback information is the failure indication information, step 305 is performed.

Step 305: The UE resends the uplink data to the eNB.

In this step, after determining that the downlink feedback information is the failure indication information, the UE learns that the uplink data is unsuccessfully transmitted this time; and the UE randomly generates a backoff window, and then resends the uplink data. Specifically, when resending the uplink data, the UE sends the uplink data to the eNB still in the connectionless data transmission manner.

In Embodiment 3 of the present invention, UE adds identity information that is corresponding to the UE while sending uplink data, an eNB and the UE determine, according to a time-frequency resource of the uplink data sent by the UE and the identity information, a downlink time-frequency resource of downlink feedback information that is corresponding to the UE, different UEs are distinguished by using different downlink time-frequency resources, and the eNB sends, in the time-frequency resource that is corresponding to the UE, the downlink feedback information that is corresponding to the UE, so that when the eNB does not successfully receive uplink data of all UEs, the eNB can notify each UE whether uplink data sent by the UE is successfully received by the eNB; therefore, in a case in which the eNB does not successfully receive the uplink data, the UE may resend the uplink data to the eNB, until the eNB successfully receives the uplink data, thereby ensuring that the eNB can successfully receive the uplink data sent by the UE, and improving reliability of a communications system that uses a connectionless data transmission manner.

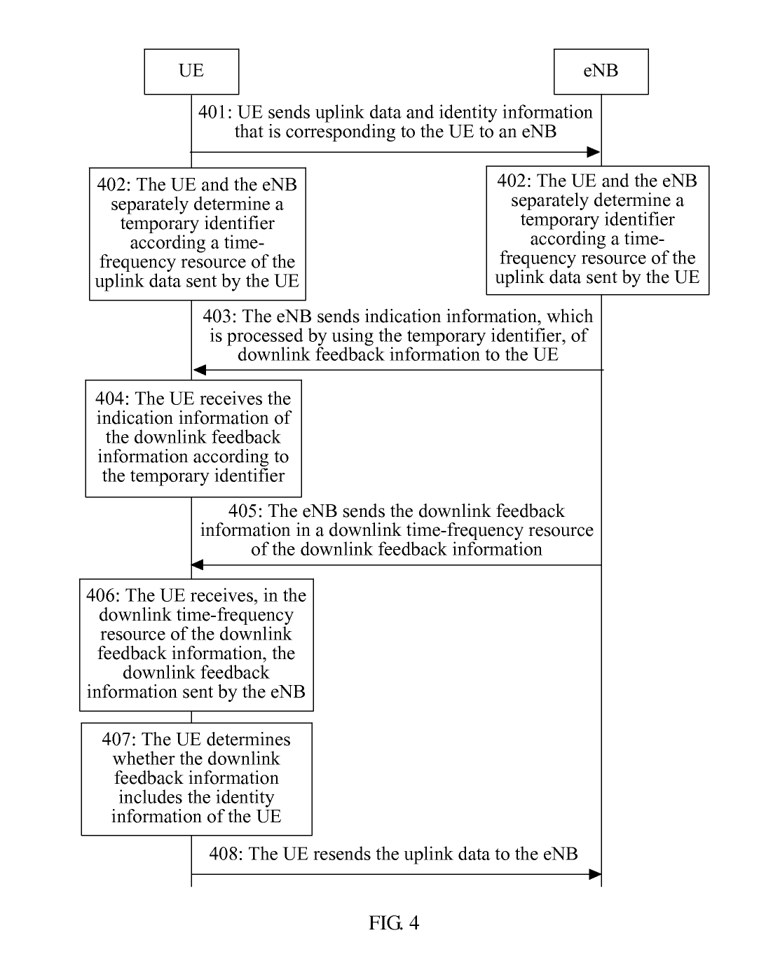

FIG. 4 is a flowchart of a feedback information transmission method according to Embodiment 4 of the present invention. As shown in FIG. 4, the method includes the following process.

Step 401: UE sends uplink data and identity information that is corresponding to the UE to an eNB.

In this step, the UE sends the uplink data to the eNB in a connectionless data transmission manner, and adds the identity information that is corresponding to the UE while sending the uplink data.

In Embodiment 4 of the present invention, the identity information may use at least one piece of the following information: a Medium Access Control (MAC) address, a UE identifier, an Internet Protocol (IP) address, and partial information of uplink data. Specifically, in Embodiment 4 of the present invention, identity information that can be in a one-to-one correspondence with each UE is used, and the identity information is long. For example, a MAC address of the UE, a user equipment identifier (UE ID), an IP address, or partial information of the uplink data may be used.

Identity information in Embodiment 4 of the present invention is long, and is approximately 48 bits to 128 bits. The identity information is in a one-to-one correspondence with the UE, and all different UEs can be distinguished completely. The partial information of the uplink data may be used as the identity information. Specifically, several bits of the uplink data sent by the UE are taken out to be used as the identity information; or several bits of the uplink data sent by the UE are taken out and undergo simple computation to be used as the identity information; when a quantity of bits that are taken out is great, a probability that identity information of different UEs is duplicate is extremely small; therefore, it may be considered that different UEs can be completely distinguished in a manner in which partial information of uplink data is used as identity information.

Step 402: The UE and the eNB separately determine a temporary identifier according to a time-frequency resource of the uplink data sent by the UE.

In this step, after sending the uplink data that carries the identity information, the UE determines the temporary identifier according to the time-frequency resource of the uplink data sent by the UE. In an implementation manner, the temporary identifier may be a contention access radio network temporary identifier (CA-RNTI). In addition, after receiving the uplink data that carries the identity information and that is sent by the UE, the eNB also determines the temporary identifier according to the time-frequency resource of the uplink data sent by the UE. Specifically, a same correspondence between a time-frequency resource and a temporary identifier is preset on the UE and the eNB, and both the UE and the eNB determine, according to the correspondence, the temporary identifier that is corresponding to the time-frequency resource of the uplink data sent by the UE. Because both the UE and the eNB determine the temporary identifier according to the same correspondence and the time-frequency resource of the uplink data sent by the UE, for UE, a temporary identifier determined by the UE is consistent with a temporary identifier determined by the eNB.

Step 403: The eNB sends indication information, which is processed by using the temporary identifier, of downlink feedback information to the UE.

In this step, the eNB sends the indication information of the downlink feedback information to the UE, and the indication information, which is sent by the eNB to the UE, of the downlink feedback information is processed by using the temporary identifier. Specifically, the indication information of the downlink feedback information may be processed by using the temporary identifier in at least the following two manners. Manner 1: The eNB adds the temporary identifier while sending the indication information of the downlink feedback information. Manner 2: For each different time-frequency resource, the eNB scrambles, by using a temporary identifier that is corresponding to each time-frequency resource, cyclic redundancy check (Cyclic Redundancy Check, CRC for short) bits in indication information, which is corresponding to UE that sends uplink data in the time-frequency resource, of downlink feedback information, and then sends scrambled indication information of the downlink feedback information on a preset channel. The indication information of the downlink feedback information includes a downlink time-frequency resource and a feedback packet size of the downlink feedback information.

Step 404: The UE receives the indication information of the downlink feedback information according to the temporary identifier.

In this step, the UE receives the indication information of the downlink feedback information according to the temporary identifier, where the indication information of the downlink feedback information includes the downlink time-frequency resource and the feedback packet size of the downlink feedback information; and the UE learns the downlink time-frequency resource of the downlink feedback information according to the indication information of the downlink feedback information. For manner 1 described in step 403, each UE matches a temporary identifier of the UE with a temporary identifier carried in a downlink time-frequency resource, and receives indication information, which matches the temporary identifier of the UE, of downlink feedback information. For manner 2 described in step 403, each UE descrambles the CRC bits on the foregoing preset channel by using a respective temporary identifier of the UE, and each UE acquires indication information, which is corresponding to a time-frequency resource of uplink data sent by the UE, of downlink feedback information.

Step 405: The eNB sends the downlink feedback information in a downlink time-frequency resource of the downlink feedback information.

In this step, the eNB sends, in the downlink time-frequency resource of the downlink feedback information, the downlink feedback information, where the downlink feedback information sent by the eNB includes the identity information of the UE that is successfully received by the eNB.

Step 406: The UE receives, in the downlink time-frequency resource of the downlink feedback information, the downlink feedback information sent by the eNB.

In this step, the UE receives, in the downlink time-frequency resource of the downlink feedback information, the downlink feedback information sent by the eNB. Specifically, the UE receives the downlink feedback information according to the downlink time-frequency resource and the feedback packet size, where the downlink feedback information includes the identity information of the UE that is successfully received by the eNB.

Step 407: The UE determines whether the downlink feedback information includes the identity information of the UE.

In this step, the UE determines whether the downlink feedback information includes the identity information of the UE, and if the downlink feedback information includes the identity information of the UE, the process is ended; or if the downlink feedback information does not include the identity information of the UE, step 408 is performed.

Step 408: The UE resends the uplink data to the eNB.

In this step, after determining that the downlink feedback information does not include the identity information of the UE, the UE learns that the uplink data is unsuccessfully sent this time; and the UE randomly generates a backoff window, and then resends the uplink data. Specifically, when resending the uplink data, the UE sends the uplink data to the eNB still in the connectionless data transmission manner.

In Embodiment 4 of the present invention, UE adds identity information that is corresponding to the UE while sending uplink data, all identity information is in a one-to-one correspondence with all UEs, an eNB sends downlink feedback information to the UE, where the downlink feedback information includes identity information of the UE correctly received by the eNB, and different UEs are distinguished by using the identity information, so that when the eNB does not successfully receive uplink data of all UEs, the eNB can notify each UE whether uplink data sent by the UE is successfully received by the eNB; therefore, in a case in which the eNB does not successfully receive the uplink data, the UE may resend the uplink data to the eNB, until the eNB successfully receives the uplink data, thereby ensuring that the eNB can successfully receive the uplink data sent by the UE, and improving reliability of a communications system that uses a connectionless data transmission manner.

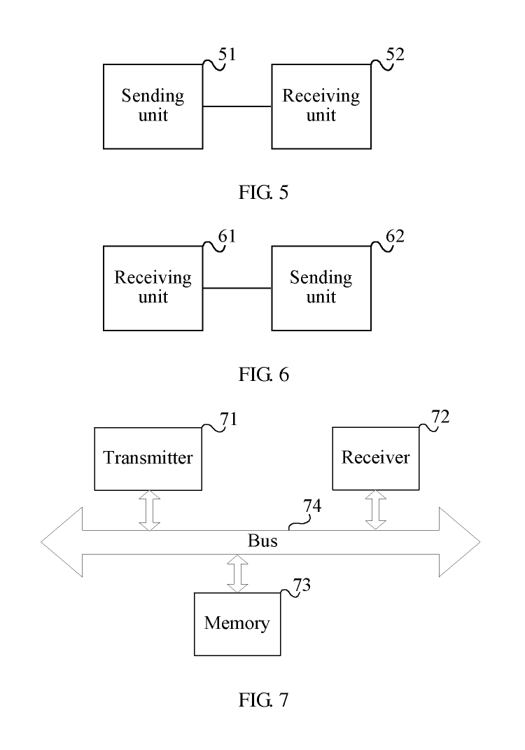

FIG. 5 is a schematic structural diagram of UE according to Embodiment 5 of the present invention. As shown in FIG. 5, the UE includes at least a sending unit 51 and a receiving unit 52.

The sending unit 51 is configured to send uplink data and identity information that is corresponding to the UE to an eNB. Specifically, the sending unit 51 sends, in a connectionless data transmission manner, the uplink data and the identity information that is corresponding to the UE to the eNB.

The receiving unit 52 is configured to receive downlink feedback information of the UE that is sent by the eNB according to the identity information.

Based on the foregoing technical solution, further, in a first implementation manner, the identity information includes at least one of a random code, a preamble sequence, and interleaver information. Correspondingly, the receiving unit 52 is specifically configured to determine, according to a preset resource mapping policy, a downlink time-frequency resource that is corresponding to the UE. The resource mapping policy includes: determining, according to an uplink time-frequency resource of the uplink data sent by the UE and the identity information that is corresponding to the UE, the downlink time-frequency resource that is corresponding to the UE; or determining, according to the identity information that is corresponding to the UE, the downlink time-frequency resource that is corresponding to the UE. The receiving unit 52 is further specifically configured to receive, in the downlink time-frequency resource that is corresponding to the UE, the downlink feedback information sent by the eNB, where the downlink feedback information includes success indication information or failure indication information.

Based on the foregoing technical solution, further, in the first implementation manner, in a case in which the resource mapping policy is the determining, according to an uplink time-frequency resource of the uplink data sent by the UE and the identity information that is corresponding to the UE, the downlink time-frequency resource that is corresponding to the UE, the resource mapping policy is specifically: calculating, by the receiving unit 52 according to q=(p×m+i)mod(rmax), the downlink time-frequency resource that is corresponding to the UE, where q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources.

Based on the foregoing technical solution, further, in the first implementation manner, in a case in which the resource mapping policy is the determining, according to the identity information that is corresponding to the UE, the downlink time-frequency resource that is corresponding to the UE, the resource mapping policy is specifically: calculating, by the receiving unit 52 according to q=imod(rmax), the downlink time-frequency resource that is corresponding to the UE, where q indicates an identifier of the downlink time-frequency resource that is corresponding to the UE, i indicates a sequence number of the identity information that is corresponding to the UE, and rmax indicates a maximum available quantity of downlink time-frequency resources.

Based on the foregoing technical solution, further, in a second implementation manner, the identity information includes at least one of a MAC address, a UE identifier, an IP address, and partial information of the uplink data. Correspondingly, the receiving unit 52 is specifically configured to determine a temporary identifier according to a time-frequency resource of the uplink data sent by the UE. The receiving unit 52 is further specifically configured to receive indication information of the downlink feedback information according to the temporary identifier, where the indication information of the downlink feedback information includes a downlink time-frequency resource and a feedback packet size of the downlink feedback information. The receiving unit 52 is further specifically configured to receive, in the downlink time-frequency resource of the downlink feedback information, the downlink feedback information sent by the eNB, where the downlink feedback information includes the identity information of the UE that is successfully received by the eNB.

The UE in Embodiment 5 of the present invention may be configured to perform the feedback information transmission method described in Embodiment 1 of the present invention to Embodiment 4 of the present invention, and for a specific implementation process and technical effect thereof, reference may be made to Embodiment 1 of the present invention to Embodiment 4 of the present invention, which are not described herein again.

FIG. 6 is a schematic structural diagram of an eNB according to Embodiment 6 of the present invention. As shown in FIG. 6, the eNB includes at least a receiving unit 61 and a sending unit 62.

The receiving unit 61 is configured to receive uplink data and identity information corresponding to UE that are from the UE. Specifically, the receiving unit 61 is configured to receive, in a connectionless data transmission manner, the uplink data and the identity information corresponding to the UE that are from the UE.

The sending unit 62 is configured to send downlink feedback information of the UE to the UE according to the identity information.

Based on the foregoing technical solution, further, in a first implementation manner, the identity information includes at least one of a random code, a preamble sequence, and interleaver information. Correspondingly, the sending unit 62 is specifically configured to determine, according to a preset resource mapping policy, a downlink time-frequency resource that is corresponding to the UE. The resource mapping policy includes: determining, according to an uplink time-frequency resource of the uplink data sent by the UE and the identity information that is corresponding to the UE, the downlink time-frequency resource that is corresponding to the UE; or determining, according to the identity information that is corresponding to the UE, the downlink time-frequency resource that is corresponding to the UE. The sending unit 62 is further specifically configured to send the downlink feedback information of the UE in the downlink time-frequency resource that is corresponding to the UE, where the downlink feedback information includes success indication information or failure indication information.

Based on the foregoing technical solution, further, in the foregoing first implementation manner, in a case in which the resource mapping policy is the determining, according to an uplink time-frequency resource of the uplink data sent by the UE and the identity information that is corresponding to the UE, the downlink time-frequency resource that is corresponding to the UE, the resource mapping policy is specifically: calculating, by the sending unit 62 according to q=(p×m+i)mod(rmax), the downlink time-frequency resource that is corresponding to the UE, where q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources.

Based on the foregoing technical solution, further, in the foregoing first implementation manner, in a case in which the resource mapping policy is the determining, according to the identity information that is corresponding to the UE, the downlink time-frequency resource that is corresponding to the UE, the resource mapping policy is specifically: calculating, by the sending unit 62 according to q=imod(rmax), the downlink time-frequency resource that is corresponding to the UE, where q indicates an identifier of the downlink time-frequency resource that is corresponding to the UE, i indicates a sequence number of the identity information that is corresponding to the UE, and rmax indicates a maximum available quantity of downlink time-frequency resources.

Based on the foregoing technical solution, further, in a second implementation manner, the identity information includes at least one of a MAC address, a UE identifier, an IP address, and partial information of the uplink data. Correspondingly, the sending unit 62 is specifically configured to determine a temporary identifier according to a time-frequency resource of the uplink data sent by the UE. The sending unit 62 is further specifically configured to send the temporary identifier and indication information of the downlink feedback information, where the indication information of the downlink feedback information includes a downlink time-frequency resource and a feedback packet size of the downlink feedback information. The sending unit 62 is further specifically configured to send the downlink feedback information in the downlink time-frequency resource of the downlink feedback information, where the downlink feedback information includes the identity information of the UE that is successfully received by the eNB.

The eNB in Embodiment 6 of the present invention may be configured to perform the feedback information transmission method described in Embodiment 1 of the present invention to Embodiment 4 of the present invention, and for a specific implementation process and technical effect thereof, reference may be made to Embodiment 1 of the present invention to Embodiment 4 of the present invention, which are not described herein again.

FIG. 7 is a schematic structural diagram of UE according to Embodiment 7 of the present invention. As shown in FIG. 7, the UE includes at least a transmitter 71, a receiver 72, a memory 73, and a bus 74.

The transmitter 71 is configured to send uplink data and identity information that is corresponding to the UE to an eNB. Specifically, the transmitter 71 is configured to send, in a connectionless data transmission manner, the uplink data and the identity information that is corresponding to the UE to the eNB.

The receiver 72 is configured to receive downlink feedback information of the UE that is sent by the eNB according to the identity information.

The memory 73 is configured to store the identity information that is corresponding to the UE.

The bus 74 is configured to connect the transmitter 71, the receiver 72, and the memory 73, where the transmitter 71, the receiver 72, and the memory 73 communicate with one another by using the bus 74.

Based on the foregoing technical solution, further, in a first implementation manner, the identity information includes at least one of a random code, a preamble sequence, and interleaver information. Correspondingly, the receiver 72 is specifically configured to determine, according to a preset resource mapping policy, a downlink time-frequency resource that is corresponding to the UE. The resource mapping policy includes: determining, according to an uplink time-frequency resource of the uplink data sent by the UE and the identity information that is corresponding to the UE, the downlink time-frequency resource that is corresponding to the UE; or determining, according to the identity information that is corresponding to the UE, the downlink time-frequency resource that is corresponding to the UE. The receiver 72 is further specifically configured to receive, in the downlink time-frequency resource that is corresponding to the UE, the downlink feedback information sent by the eNB, where the downlink feedback information includes success indication information or failure indication information.

Based on the foregoing technical solution, further, in the first implementation manner, in a case in which the resource mapping policy is the determining, according to an uplink time-frequency resource of the uplink data sent by the UE and the identity information that is corresponding to the UE, the downlink time-frequency resource that is corresponding to the UE, the resource mapping policy is specifically: calculating, by the receiver 72 according to q=(p×m+i)mod(rmax), the downlink time-frequency resource that is corresponding to the UE, where q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources.

Based on the foregoing technical solution, further, in the first implementation manner, in a case in which the resource mapping policy is the determining, according to the identity information that is corresponding to the UE, the downlink time-frequency resource that is corresponding to the UE, the resource mapping policy is specifically: calculating, by the receiver 72 according to q=imod(rmax), the downlink time-frequency resource that is corresponding to the UE, where q indicates an identifier of the downlink time-frequency resource that is corresponding to the UE, i indicates a sequence number of the identity information that is corresponding to the UE, and rmax indicates a maximum available quantity of downlink time-frequency resources.

Based on the foregoing technical solution, further, in a second implementation manner, the identity information includes at least one of a MAC address, a UE identifier, an IP address, and partial information of the uplink data. Correspondingly, the receiver 72 is specifically configured to determine a temporary identifier according to a time-frequency resource of the uplink data sent by the UE. The receiver 72 is further specifically configured to receive indication information of the downlink feedback information according to the temporary identifier, where the indication information of the downlink feedback information includes a downlink time-frequency resource and a feedback packet size of the downlink feedback information. The receiver 72 is further specifically configured to receive, in the downlink time-frequency resource of the downlink feedback information, the downlink feedback information sent by the eNB, where the downlink feedback information includes the identity information of the UE that is successfully received by the eNB.

The UE in Embodiment 7 of the present invention may be configured to perform the feedback information transmission method described in Embodiment 1 of the present invention to Embodiment 4 of the present invention, and for a specific implementation process and technical effect thereof, reference may be made to Embodiment 1 of the present invention to Embodiment 4 of the present invention, which are not described herein again.

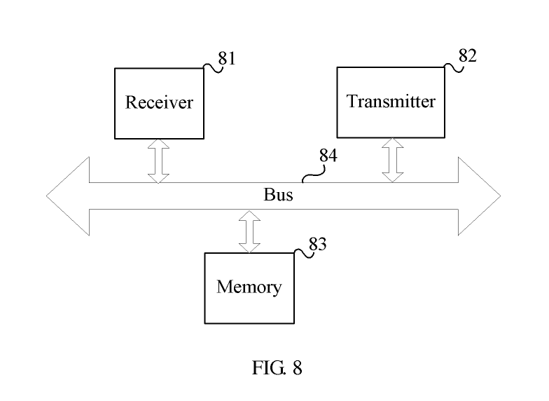

FIG. 8 is a schematic structural diagram of an eNB according to Embodiment 8 of the present invention. As shown in FIG. 8, the eNB includes at least a receiver 81, a transmitter 82, a memory 83, and a bus 84.

The receiver 81 is configured to receive uplink data and identity information corresponding to user equipment UE that are from the UE. Specifically, the receiver 81 is configured to receive, in a connectionless data transmission manner, the uplink data and the identity information corresponding to the user equipment UE that are from the UE.

The transmitter 82 is configured to send downlink feedback information of the UE to the UE according to the identity information.

The memory 83 is configured to store the identity information that is corresponding to the UE.

The bus 84 is configured to connect the transmitter 82, the receiver 81, and the memory 83, where the transmitter 82, the receiver 81, and the memory 83 communicate with one another by using the bus 84.

Based on the foregoing technical solution, further, in a first implementation manner, the identity information includes at least one of a random code, a preamble sequence, and interleaver information. Correspondingly, the transmitter 82 is specifically configured to determine, according to a preset resource mapping policy, a downlink time-frequency resource that is corresponding to the UE. The resource mapping policy includes: determining, according to an uplink time-frequency resource of the uplink data sent by the UE and the identity information that is corresponding to the UE, the downlink time-frequency resource that is corresponding to the UE; or determining, according to the identity information that is corresponding to the UE, the downlink time-frequency resource that is corresponding to the UE. The transmitter 82 is further specifically configured to send the downlink feedback information of the UE in the downlink time-frequency resource that is corresponding to the UE, where the downlink feedback information includes success indication information or failure indication information.

Based on the foregoing technical solution, further, in the foregoing first implementation manner, in a case in which the resource mapping policy is the determining, according to an uplink time-frequency resource of the uplink data sent by the UE and the identity information that is corresponding to the UE, the downlink time-frequency resource that is corresponding to the UE, the resource mapping policy is specifically: calculating, by the transmitter 82 according to q=(p×m+i)mod(rmax), the downlink time-frequency resource that is corresponding to the UE, where q indicates an identifier of the downlink time-frequency resource that is corresponding to the UE, p indicates an identifier of the uplink time-frequency resource of the uplink data sent by the UE, m indicates a total quantity of pieces of identity information in a system, i indicates a sequence number of the identity information that is corresponding to the UE, and rmax indicates a maximum available quantity of downlink time-frequency resources.

Based on the foregoing technical solution, further, in the foregoing first implementation manner, in a case in which the resource mapping policy is the determining, according to the identity information that is corresponding to the UE, the downlink time-frequency resource that is corresponding to the UE, the resource mapping policy is specifically: calculating, by the transmitter 82 according to q=imod(rmax), the downlink time-frequency resource that is corresponding to the UE, where q indicates an identifier of the downlink time-frequency resource that is corresponding to the UE, i indicates a sequence number of the identity information that is corresponding to the UE, and rmax indicates a maximum available quantity of downlink time-frequency resources.

Based on the foregoing technical solution, further, in a second implementation manner, the identity information includes at least one of a MAC address, a UE identifier, an IP address, and partial information of the uplink data. Correspondingly, the transmitter 82 is specifically configured to determine a temporary identifier according to a time-frequency resource of the uplink data sent by the UE. The transmitter 82 is further specifically configured to send the temporary identifier and indication information of the downlink feedback information, where the indication information of the downlink feedback information includes a downlink time-frequency resource and a feedback packet size of the downlink feedback information. The transmitter 82 is further specifically configured to send the downlink feedback information in the downlink time-frequency resource of the downlink feedback information, where the downlink feedback information includes the identity information of the UE that is successfully received by the eNB.

The eNB in Embodiment 8 of the present invention may be configured to perform the feedback information transmission method described in Embodiment 1 of the present invention to Embodiment 4 of the present invention, and for a specific implementation process and technical effect thereof, reference may be made to Embodiment 1 of the present invention to Embodiment 4 of the present invention, which are not described herein again.

It should be noted that, for ease of description, the foregoing method embodiments are described as a combination of a series of actions. However, persons skilled in the art should understand that the present invention is not limited to the described sequence of the actions, because some steps may be performed in another sequence or performed at the same time according to the present invention. In addition, persons skilled in the art should also understand that the embodiments described in this specification all belong to exemplary embodiments, and the involved actions and modules are not necessarily required by the present invention.

In the foregoing embodiments, the description of each embodiment has respective focuses. For a part that is not described in detail in an embodiment, reference may be made to related descriptions in other embodiments.

Persons of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

1. A feedback information transmission method, comprising:
sending, by user equipment(UE), uplink data and identity information that is corresponding to the UE to a base station(eNB); and
receiving, by the UE, downlink feedback information of the UE that is sent by the eNB according to the identity information.

2. The method according to claim 1, wherein
the identity information comprises at least one of a random code, a preamble sequence, and interleaver information.

3. The method according to claim 2, wherein the receiving, by the UE, downlink feedback information of the UE that is sent by the eNB according to the identity information comprises:
receiving, by the UE in a determined downlink time-frequency resource that is corresponding to the UE, the downlink feedback information sent by the eNB, wherein the downlink feedback information comprises success indication information or failure indication information.

4. The method according to claim 1, wherein
the identity information comprises at least one of a Media Access Control(MAC) address, a UE identifier, an Internet Protocol(IP) address, and partial information of the uplink data.

5. The method according to claim 4, wherein the receiving, by the UE, downlink feedback information of the UE that is sent by the eNB according to the identity information comprises:
receiving, by the UE in a downlink time-frequency resource of the downlink feedback information to be received, the downlink feedback information sent by the eNB, wherein the downlink feedback information comprises the identity information of the UE that is successfully received by the eNB.

6. A feedback information transmission method, comprising:
receiving, by a base station(eNB), uplink data and identity information corresponding to user equipment(UE) that are from the UE; and
sending, by the eNB, downlink feedback information of the UE to the UE according to the identity information.

7. The method according to claim 6, wherein
the identity information comprises at least one of a random code, a preamble sequence, and interleaver information.

8. The method according to claim 7, wherein the sending, by the eNB, downlink feedback information of the UE to the UE according to the identity information comprises: sending, by the eNB, the downlink feedback information of the UE in a determined downlink time-frequency resource that is corresponding to the UE, wherein the downlink feedback information comprises success indication information or failure indication information.

9. The method according to claim 6, wherein
the identity information comprises at least one of a Media Access Control(MAC) address, a UE identifier, an Internet Protocol(IP) address, and partial information of the uplink data.

10. The method according to claim 9, wherein the sending, by the eNB, downlink feedback information of the UE to the UE according to the identity information comprises:
sending, by the eNB, the downlink feedback information in a downlink time-frequency resource of the downlink feedback information, wherein the downlink feedback information comprises the identity information of the UE that is successfully received by the eNB.

11. User equipment(UE), comprising:
a transmitter, configured to send uplink data and identity information that is corresponding to the UE to a base station(eNB);
a receiver, configured to receive downlink feedback information of the UE that is sent by the eNB according to the identity information;
a memory, configured to store the identity information that is corresponding to the UE; and
a bus, configured to connect the transmitter, the receiver, and the memory, wherein the transmitter, the receiver, and the memory communicate with one another by using the bus.

12. The UE according to claim 11, wherein
the identity information comprises at least one of a random code, a preamble sequence, and interleaver information.

13. The UE according to claim 12, wherein
the receiver is configured to receive, in a determined downlink time-frequency resource that is corresponding to the UE, the downlink feedback information sent by the eNB, wherein the downlink feedback information comprises success indication information or failure indication information.

14. The UE according to claim 11, wherein
the identity information comprises at least one of a Media Access Control(MAC) address, a UE identifier, an Internet Protocol(IP) address, and partial information of the uplink data.

15. The UE according to claim 14, wherein
the receiver is configured to receive, in a downlink time-frequency resource of the downlink feedback information to be received, the downlink feedback information sent by the eNB, wherein the downlink feedback information comprises the identity information of the UE that is successfully received by the eNB.

16. A base station(eNB), comprising:
a receiver, configured to receive uplink data and identity information corresponding to user equipment(UE) that are from the UE;
a transmitter, configured to send downlink feedback information of the UE to the UE according to the identity information;
a memory, configured to store the identity information that is corresponding to the UE; and
a bus, configured to connect the transmitter, the receiver, and the memory, wherein the transmitter, the receiver, and the memory communicate with one another by using the bus.

17. The eNB according to claim 16, wherein
the identity information comprises at least one of a random code, a preamble sequence, and interleaver information.

18. The eNB according to claim 17, wherein
the transmitter is configured to send the downlink feedback information of the UE in a determined downlink time-frequency resource that is corresponding to the UE, wherein the downlink feedback information comprises success indication information or failure indication information.

19. The eNB according to claim 16, wherein
the identity information comprises at least one of a Media Access Control(MAC) address, a UE identifier, an Internet Protocol(IP) address, and partial information of the uplink data.

20. The eNB according to claim 19, wherein
the transmitter is configured to send the downlink feedback information in a downlink time-frequency resource of the downlink feedback information, wherein the downlink feedback information comprises the identity information of the UE that is successfully received by the eNB.
